(19) United States
(12) Patent Application Publication
(10) Pub. No.: US 2017/0057371 A1
(43) Pub. Date: Mar. 2, 2017

(54) INDUCTIVELY CHARGING AN ELECTRIC VEHICLE

(71) Applicant: Robert Bosch GmbH, Stuttgart (DE)

(72) Inventor: Stefan NORDBRUCH, Kornwestheim (DE)

(21) Appl. No.: 15/236,639

(22) Filed: Aug. 15, 2016

(30) Foreign Application Priority Data
Aug. 28, 2015 (DE) 102015216480.2

(51) Int. Cl. B60L 11/18; H02J 7/02

(52) U.S. Cl. CPC B60L 11/1838; B60L 11/182; H02J 7/025

(57) ABSTRACT

A method for inductively charging an electric vehicle, including monitoring the surroundings of an electric vehicle during inductive charging of the electric vehicle, checking, based on the monitoring, whether an object has moved into the surroundings, interrupting the inductive charging when the check has revealed that an object has moved into the surroundings. A corresponding device, an electric vehicle and a computer program are also described.

### CROSS REFERENCE

The present application claims the benefit under 35 U.S.C. §119 of German Patent Application No. DE 102015216480.2 filed on Aug. 28, 2015.

### FIELD

The present invention relates to a method and a device for inductively charging an electric vehicle. The present invention also relates to an electric vehicle and a computer program.

### BACKGROUND INFORMATION

Conventional electric vehicles are available that are inductively chargeable. However, for health reasons, during inductive charging of an electric vehicle, persons who have pacemakers, for example, should not come into the proximity of the electric vehicle while the electric vehicle is being inductively charged, because the inductive charging process may possibly cause interference in the operation of the pacemaker.

### SUMMARY

An object of the present invention is to provide an efficient concept for inductively charging an electric vehicle efficiently.

According to one aspect of the present invention, a method for inductively charging an electric vehicle is provided, including the following steps:
monitoring the surroundings of an electric vehicle during inductive charging of the electric vehicle,
checking on whether an object has moved into the surroundings, based on the monitoring,
interrupting the inductive charging when the check has revealed that an object has moved into the surroundings.

According to another aspect of the present invention, a device for inductively charging an electric vehicle is provided, including:
a charging station which is designed to inductively charge an electric vehicle,
a monitoring device for monitoring the surroundings of an electric vehicle during inductive charging of the electric vehicle,
a checking unit for checking whether an object has moved into the surroundings, based on the monitoring, and
an interruption unit for interrupting the inductive charging when the check has revealed that an object has moved into the surroundings.

According to another aspect, an electric vehicle which is designed to be charged inductively is provided, including:
a monitoring unit for monitoring the surroundings of an electric vehicle during inductive charging of the electric vehicle with the aid of a charging station,
a checking unit for checking whether an object has moved into the surroundings based on the monitoring,
a communications interface for transmitting an interrupt request to the charging station to interrupt the inductive charging when the check has revealed that an object has moved into the surroundings.

According to another aspect, a computer program provided which includes program code for carrying out the method for inductively charging an electric vehicle when the computer program is executed on a computer.

The present invention thus includes in particular and among other things carrying out an analysis (monitoring and checking) of the surroundings (monitoring and checking) during the inductive charging of the electric vehicle, so that the inductive charging process is interrupted (interruption step) as soon as an object has moved into the surroundings of the electric vehicle.

This yields in particular the technical advantage that the electric vehicle may be efficiently charged inductively. In particular this yields the technical advantage that there is no interference with operation of a pacemaker when the object is a person having a pacemaker.

In general, this yields the technical advantage that health risks for animate beings entering the surroundings during charging may be reduced or prevented. In particular, this yields the technical advantage that, if the object is an electronic object, it cannot be disturbed by inductive charging of the electric vehicle or interference may be reduced if the object has moved into the surroundings. Animate beings include animals, for example. Due to their size, animals may in some cases end up directly below the electric vehicle, which may result in health risks for the animal.

The surroundings include in particular the immediate vicinity of the electric vehicle. For example, the surroundings include an area a maximum distance of 2 meters away from the electric vehicle, in particular 1 meter. In other words, up to maximal 2 meters, in particular 1 meter, relative to the electric vehicle, it is monitored whether an object is in the surroundings.

The fact that the electric vehicle is being charged inductively means in particular that an electrical energy store of the electric vehicle is being charged inductively. This electrical energy store stores electrical power for an electric motor (i.e., for the drive motor) of the electric vehicle. Such an electrical energy store may be referred to as a traction battery, for example. An electrical energy store includes rechargeable batteries in particular. Thus, for example, the traction battery includes one or multiple rechargeable batteries.

According to another specific embodiment, it is provided that a check is carried out, based on the monitoring, to ascertain whether the object has left the surroundings, the inductive charging being continued when the check has revealed that the object has left the surroundings.

Therefore, this yields in particular the technical advantage that inductive charging may be continued efficiently because now there is no longer any risk for the object if the electric vehicle is being charged. The inductive charging may be continued in this respect. Therefore, this yields in particular the technical advantage that an electrical energy store of the electric vehicle may continue to be charged.

According to another specific embodiment, it is provided that when the inductive charging is interrupted, a message that the inductive charging has been interrupted is sent via a communications network.

This yields in particular the technical advantage that a user of the communications network is informed that the inductive charging has been interrupted. Accordingly, the user of the communications network may then take measures to eliminate the interference (i.e., the object).

The user of the communications network is, for example, a former driver of the electric vehicle, who has parked the electric vehicle at the charging station for the purpose of inductive charging. The user of the communications network is, for example, an operator of the charging station, in particular the device for inductively charging an electric vehicle, so that the operator may then take suitable measures.

The user of the communications network may be informed of the interruption with the aid of a terminal, for example, in particular with the aid of a mobile terminal, in particular with the aid of a cellular telephone. This means that the message is sent to such a terminal via the communications network, for example.

A communications network includes in particular a wireless and/or a hard-wired communications network. A hard-wired communications network includes in particular an Ethernet communications network. A wireless communications network includes in particular a mobile radio communications network and/or a WLAN communications network.

According to one specific embodiment, a communication via the communications network is or, respectively, will be encrypted.

The terminology “respectively” includes in particular the phrase “and/or.”

According to one specific embodiment, it is provided that monitoring of the surroundings includes monitoring of the surroundings with the aid of a vehicle surroundings sensor system of the electric vehicle.

This yields in particular the technical advantage that the vehicle surroundings sensor system of the electric vehicle is utilized efficiently for monitoring the surroundings. Efficient monitoring of the surroundings is thus achieved.

A vehicle surroundings sensor system includes, for example, one or more of the following surroundings sensors: radar sensor, ultrasonic sensor, laser sensor, video sensor, magnetic sensor and LIDAR sensor.

Therefore, this means that the surroundings of the electric vehicle are detected by sensors of the vehicle surroundings sensor system, a check being carried out to ascertain whether an object has moved into the surroundings based on this detection via sensors.

According to one specific embodiment, it is provided that the vehicle surroundings sensor system ascertains data on the surroundings corresponding to detection by sensors and sends these data via a vehicle communications interface to the device for inductive charging of an electric vehicle. It is thus advantageously possible to carry out an evaluation, i.e., in particular a check outside of the vehicle.

According to one specific embodiment, it is provided that the check is carried out internally within the vehicle, in particular with the aid of the checking unit.

According to one specific embodiment, it is provided that the monitoring of the surroundings includes monitoring of the surroundings with the aid of a surroundings sensor system outside of the vehicle.

Therefore, this yields the technical advantage in particular that efficient monitoring of the surroundings may be carried out. The monitoring of the surroundings is thus independent of any vehicle surroundings sensor system of the electric vehicle.

According to one specific embodiment, a surroundings sensor system outside of the vehicle similar to the vehicle surroundings sensor system of the electric vehicle includes one or more of the corresponding surroundings sensors. The statements made in this regard also apply here accordingly.

In another specific embodiment, it is provided that one or more of the method steps are recorded electronically.

Therefore, this yields in particular the technical advantage that the implementation of the method may also be reenacted at a later point in time. In particular, the electronic recording may be improved to improve the quality of the inductive charging, so that the inductive charging may be carried out even more efficiently in the future.

According to one specific embodiment, it is provided that the device for inductively charging an electrical vehicle is designed or configured to carry out the method for inductively charging an electric vehicle.

Technical functionalities of the method for inductively charging an electric vehicle are derived similarly from corresponding technical functionalities of the device for inductively charging an electric vehicle and vice-versa.

According to one specific embodiment, it is provided that the electric vehicle is designed or configured to carry out the method for inductively charging an electric vehicle.

Technical functionalities of the electric vehicle are similarly derived from corresponding technical functionalities of the method for inductively charging an electric vehicle and vice-versa.

In one specific embodiment, it is provided that the surroundings are already being monitored prior to the start of inductive charging, so that even during the monitoring prior to the start of inductive charging, a check is carried out based on the monitoring to ascertain whether an object has moved into the surroundings, the inductive charging being started only if no object has moved into the surroundings.

This achieves in particular the technical advantage that it is ensured that charging is started only if no object has moved into the surroundings. This achieves efficient charging in an advantageous manner in particular.

The present invention is explained in greater detail below on the basis of preferred exemplary embodiments.

### BRIEF DESCRIPTION OF THE DRAWINGS

FIG. 1 shows a flow chart of a method for inductively charging an electric vehicle.

FIG. 2 shows a device for inductively charging an electric vehicle.

FIG. 3 shows an electric vehicle.

FIG. 1 shows a flow chart of a method for inductively charging an electric vehicle.

### DETAILED DESCRIPTION OF EXAMPLE EMBODIMENTS

The method includes the following steps:
monitoring 101 of the surroundings of an electric vehicle during inductive charging of the electric vehicle,
checking 103, based on monitoring 101, whether an object has moved into the surroundings,
interrupting 105 the inductive charging when this check 103 has revealed that an object has moved into the surroundings.

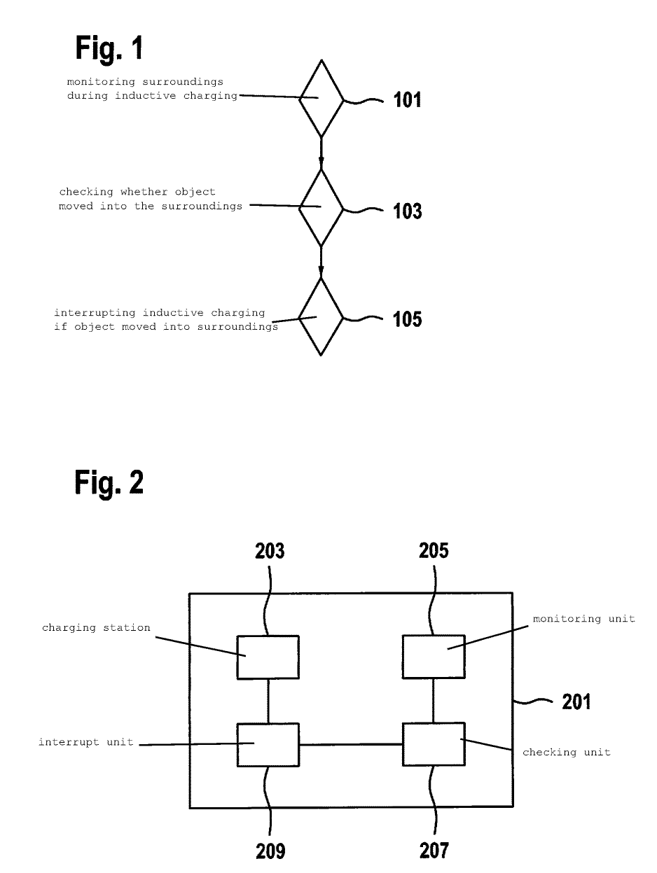

FIG. 2 shows a device 201 for inductively charging an electric vehicle.

Device 201 includes:
a charging station 203 which is designed for inductively charging an electric vehicle,
a monitoring unit 205 for monitoring the surroundings of an electric vehicle during inductive charging of the electric vehicle,
a checking unit 207 for checking, based on the monitoring, whether an object has moved into the surroundings, and
an interrupt unit 209 for interrupting the inductive charging when the check has revealed that an object has moved into the surroundings.

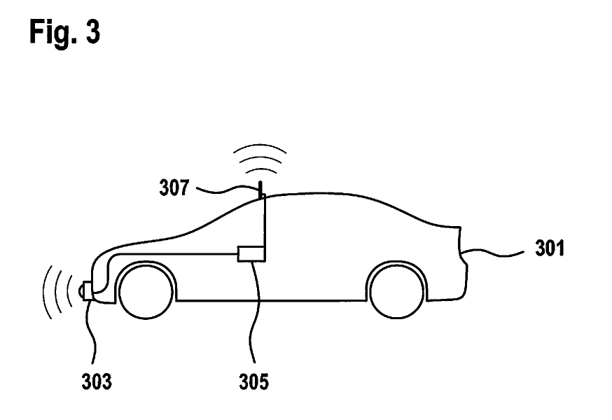

FIG. 3 shows an electric vehicle 301.

Electric vehicle 301 is designed to be charged inductively. Electric vehicle 301 includes:
a monitoring unit 303 for monitoring the surroundings of an electric vehicle during inductive charging of the electric vehicle with the aid of a charging station,
a checking unit 305 for checking, based on the monitoring, whether an object has moved into the surroundings,
a communications interface 307 for sending an interrupt request to the charging station to interrupt the inductive charging when the check has revealed that an object has moved into the surroundings.

Communications interface 307 is designed as a wireless communications interface, for example. Monitoring unit 303 includes a radar sensor, for example.

According to one specific embodiment, device 201 in FIG. 2 also includes a communications interface for receiving the interrupt request. In response to the interrupt request, interrupt unit 209 then interrupts the inductive charging of electric vehicle 301.

The present invention thus provides, among other things, in particular an efficient technical solution, which permits a safeguard during charging with induction, i.e., inductive charging. A basic idea according to the present invention may thus be regarded in particular as an analysis of the surroundings being carried out during the inductive charging as soon as an object is moving in an area around the electric vehicle and the inductive charging operation is interrupted. Whether an object is moving into the area around the electric vehicle is decided or determined or checked in particular based on the analysis of the surroundings.

According to one specific embodiment, the analysis of the surroundings is carried out in the electric vehicle by the vehicle itself. According to one specific embodiment, the electric vehicle uses for this purpose sensor systems (surroundings sensor systems) installed in the electric vehicle. For example, such sensor systems include ultrasonic sensor systems, in particular ultrasonic sensor systems of parking functions. In particular, such sensor systems include so-called “surround view systems,” for example, based on video cameras, in particular surround view systems of parking functions. In particular, such sensor systems include additional sensors present in the electric vehicle, such as camera, LIDAR, radar, laser sensors of driver assistance systems, for example.

According to one specific embodiment, the analysis of the surroundings is carried out by an external infrastructure, for example. This infrastructure includes in general cameras, light barriers or surroundings sensor systems, for example.

According to one specific embodiment, the inductive charging operation begins again automatically, i.e., is continued, when the object is no longer in the area, i.e., when the object has moved out of the area.

According to one specific embodiment, the driver and/or the charging station operator is informed about the unintentional termination. For example, the driver is informed via cellular telephone or a mobile terminal. The operator or provider of the charging station is informed via a corresponding charging management system, for example.

According to one specific embodiment, the operation, in particular the steps of the method described above for inductively charging an electric vehicle, is/are documented, i.e., in particular recorded electronically.

What is claimed is:

1. A method for inductively charging an electric vehicle, comprising:
monitoring surroundings of the electric vehicle during inductive charging of the electric vehicle;
checking, based on the monitoring, whether an object has moved into the surroundings; and
interrupting the inductive charging when the check has revealed that an object has moved into the surroundings.

2. The method as recited in claim 1, wherein, based on the monitoring, a check is carried out to ascertain whether the object has left the surroundings, the inductive charging being continued when the check has revealed that the object has left the surroundings.

3. The method as recited in claim 1, wherein, when the inductive charging is interrupted, a message that the inductive charging has been interrupted is sent via a communications network.

4. The method as recited in claim 1, wherein the monitoring of the surroundings includes monitoring of the surroundings with the aid of a vehicle surroundings sensor system of the electric vehicle.

5. The method as recited in claim 1, wherein the monitoring of the surroundings includes monitoring of the surroundings with the aid of a surroundings sensor system outside of the vehicle.

6. The method as recited in claim 1, wherein one or more of the preceding method steps are recorded electronically.

7. The method as recited in claim 1, wherein, the surroundings are already being monitored prior to a start of the inductive charging, so that prior to the start of the inductive charging, a check is already carried out during the monitoring, based on the monitoring, to ascertain whether an object has moved into the surroundings, the inductive charging being started only if no object has moved into the surroundings.

8. A device for inductively charging an electric vehicle, comprising:
a charging station designed to inductively charge an electric vehicle;
a monitoring unit for monitoring surroundings of an electric vehicle during inductive charging of the electric vehicle;
a checking unit for checking, based on the monitoring, whether an object has moved into the surroundings; and
an interrupt unit for interrupting the inductive charging when the check has revealed that an object has moved into the surroundings.

9. An electric vehicle designed to be charged inductively, comprising:
a monitoring unit for monitoring the surroundings of an electric vehicle during inductive charging of the electric vehicle with the aid of a charging station;
a checking unit for checking, based on the monitoring, whether an object has moved into the surroundings;
a communications interface for sending an interrupt request to the charging station to interrupt the inductive charging when the check has revealed that an object has moved into the surroundings.

10. A non-transitory computer readable storage medium storing a a computer program, including program code for inductively charging an electric vehicle, the program code, when executed by a computer, causing the computer to perform:
monitoring surroundings of the electric vehicle during inductive charging of the electric vehicle;
checking, based on the monitoring, whether an object has moved into the surroundings; and
interrupting the inductive charging when the check has revealed that an object has moved into the surroundings.
